(19) United States
(12) Patent Application Publication
(10) Pub. No.: US 2013/0031057 A1
(43) Pub. Date: Jan. 31, 2013

(54) Minimal Identity Recovery System and Method

(71) Applicant: Masoud Vakili, Mountain View, CA (US)

(72) Inventor: Masoud Vakili, Mountain View, CA (US)

(21) Appl. No.: 13/562,193

(22) Filed: Jul. 30, 2012

Related U.S. Application Data
(60) Provisional application No. 61/512,404, filed on Jul. 28, 2011.

(51) Int. Cl. G06F 12/16; G06F 17/30

(52) U.S. Cl. 707/640; 707/E17.005

(57) ABSTRACT

Methods and systems for storing, providing, and obtaining recovery data. The recovery data is normally used on a mobile device which is no longer available to a user who would otherwise need to perform crucial functions like operating a vehicle, identification, or financial transactions on the mobile device. Recovery data is provided on a medium which enables the user to perform crucial functions at least for a limited duration.

### CROSS-REFERENCE TO RELATED APPLICATIONS

The present application claims priority to U.S. Provisional Application Ser. No. 61/512,404, titled “Minimal Identity Recovery System and Method”, filed on Jul. 28, 2011.

### FIELD OF THE INVENTION

Various embodiments related to mobile identity and recovery are presented.

### BACKGROUND OF THE INVENTION

Increasingly, one's mobile device, such as a mobile phone or other mobile device, serves as identification, payment, key etc. Today, payments from a mobile phone or sending commands to an electronic or electromechanical system like an automobile are practiced. With technologies like RFID and NFC combined with longer range telecom networks this type of application is believed to become widely used.

### DESCRIPTION OF THE FIGURES

FIG. 1 represents the schematics of a minimal identity recovery system according to some embodiments.

FIG. 2A represents the process of storing recovery data according to some embodiments.

FIG. 2B represents a processes of identity recovery according to some embodiments.

### SUMMARY OF THE INVENTION

In one aspect, embodiments present a method comprising obtaining recovery data, which recovery data is normally used on a mobile device, and saving the recovery data in a database such that it is available for minimal identity recovery in case a user has no access to the mobile device.

Various embodiments present a method comprising providing recovery data by a server to a recovery agent, which recovery data is used normally on a mobile device belonging to a user, in case the user has no access to the mobile device.

In one aspect, embodiments present a method comprising obtaining recovery data from a server by a recovery agent, which recovery data is used normally on a mobile device, and which recovery data is used for minimal identity recovery in case a user has no access to the mobile device.

In one aspect, embodiments present a method comprising electronically loading recovery data onto a recovery medium, which recovery data is used normally on a mobile device, the method being used for minimal identity recovery in case a user has no access to the mobile device.

In one aspect, embodiments present a recovery medium for minimal identity recovery, comprising an active radio transmitter with a circuit, wherein the recovery medium also includes an antenna, wherein the circuit and the antenna are used in combination to send radio signals.

In one aspect, embodiments present a recovery medium for minimal identity recovery, comprising a passive radio transmitter having an antenna that resonates and reflects radio signal upon being in the vicinity of an active transmitter.

In one aspect, embodiments present a system comprising means for dispensing a recovery medium containing recovery data which recovery data is used normally on a mobile device.

In one aspect, embodiments present a recovery medium comprising means for storing recovery data, which recovery data is used normally on a mobile device.

In one aspect, embodiments present a method for providing recovery data, which recovery data is used normally on a first mobile device, said method comprising sending the recovery data to a second mobile device.

In one aspect, embodiments present a method for storing and providing recovery data for minimal identity recovery of a user, the recovery data normally residing on a mobile device, the method comprising allowing the user to choose in advance what capabilities the recovery data should provide.

In one aspect, embodiments present a method for providing a rental vehicle to a user, the method comprising providing code to a mobile device in possession of the user, which code is adapted to enable the mobile device to send a radio signal to operate a rental vehicle.

### DETAILED DESCRIPTION

The embodiments and implementations described here are only exemplary. It will be appreciated by those skilled in the art that these embodiments may be practiced without certain specific details or with alternative detailed implementation without departing from the scope of the invention. In some instances however, certain obvious details have been eliminated to avoid obscuring inventive aspect the embodiments.

While losing one's car key or wallet has always been a nuisance, a number of traditional techniques have been in place to remedy that, which range from a coat hook to open a car door, a locksmith, calling DMV (or equivalent outside the US), bank of financial institution and cancelling all your credit cards and ordering new ones, etc. There is however no comprehensive solution to remedy losing one's mobile device so long as transportation, payment, entrance and other privileges are concerned.

Embodiments presented here relate to minimal identity recovery in cases where one does not have access to one's mobile device. Such instances may occur when one, among other occasions, loses, forgets, or misplaces one's mobile device. Or the mobile device might become inoperative, due to corruption, hacking, mobile identity theft, breaking, shattering, low battery or power, etc.

The embodiments presented therefor enable a user who has no longer access to his or her mobile device to perform such crucial functions as a smartkey function and a credit card function and a user identification function. These functions could be restored on a recovery medium for at least temporary use. The recovery medium should be easily accessible in case the user loses his or her mobile device and could be much cheaper and with more limited capabilities than the lost mobile device. The recovery medium could therefore be used on a temporary basis to perform these functions.

One example is that one might go out on a weekend night and stay late somewhere, and upon return to one's automobile not be able to locate one's mobile device.

Minimal identity recovery as presented here refers to retrieving and recovering enough data onto a recovery medium, for example on a temporary basis, such that the user could perform certain functions. In addition the recovery medium could optionally be valid for just enough time till the user's lost, unavailable, or non-functioning mobile device is recovered, repaired, or emulated and/or replaced.

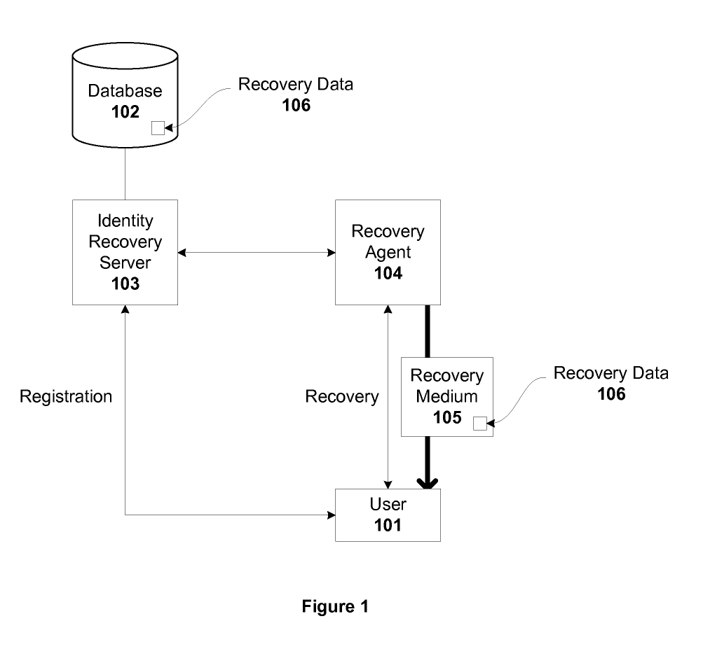

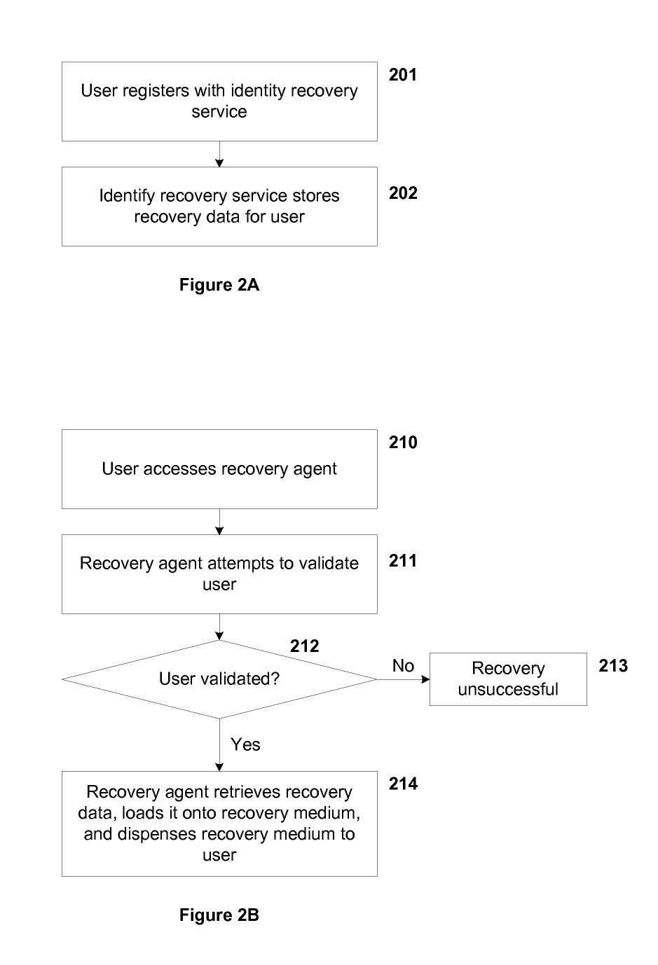

FIG. 1 is a block diagram illustrating an exemplary embodiment of an identity recovery system as described herein. To use such a system, in one embodiment as shown in FIG. 1, a user 101 enters or registers certain information in a database 102 upon signing up for an identity recovery service, for example as provided by a server 103. FIG. 2a is a flow diagram illustrating such a method for registering with an identity recovery service, according to one embodiment. Alternatively such registration could be done automatically, say with download from the user's mobile device itself, or semi-automatically. Such information may include, among other things, personal identification or authentication data, biometric data, challenge questions and answers, vehicle make and model and smartkey electronic and communication specification data, entry fob electronic and communication data, etc. Generally speaking these could be referred to as identification and authentication data on the one hand and recovery data on the other.

In some embodiments, such as further shown in FIG. 1, upon need, a user 101 would access a recovery agent 104 which could be an automatic or semi-automatic (with help from a live agent, an actual person on a voice line) dispensing machine in which case the machine could dispense a recovery medium 105. Alternatively, the recovery agent 104 may be implemented as a software application comprising a mobile component residing on the recovery medium 105 (such as another mobile device). Upon user identification and validation, the recovery agent 104 retrieves the recovery data 106 from the database 102 and loads such data onto the recovery medium 105. Once the user 101 has the recovery medium 105 in possession, the user 101 can go about his or her business with minimal or no interruption or difficulty until the mobile device or an emulation of it is recovered. FIG. 2b is a flow diagram illustrating such a method for using an identity recovery service, according to one embodiment. For instance the recovery data 106 may comprise sufficient information such that one would be able to access one's automobile and put it in ignition and drive it, have entry access to one's home, present driver license information upon need, make payments, or retrieve cash, etc. or any subset or superset of these functions.

In some embodiments, automatic electronic multi-factor authentication could be used to identify and validate the user. In some embodiments a live agent's identification and assistance could be used in addition.

In some embodiments, the recovery medium may include an ASIC (Application Specific Integrated Circuit) device or any other electronic structure on which the recovery data is loaded as firmware or software. It may also include a radio transmitter or reflector capable of communicating with desired devices and systems just as if the mobile device was present for certain purposes.

In some embodiments, the recovery medium includes an active radio transmitter system. Such a system is used in most smartkeys in vehicles today, where the transmitter sends short-range signal pulses to multiple antennae in a vehicle to ascertain that the user is near or inside the vehicle. It is then used to allow ignition. Such a system may require a power source like a battery which may come as a small component on the recovery medium.

In some embodiments the recovery medium includes a passive radio transmitter depending on use and application. Such a transmitter is basically a reflector that identifies the proximity of the user, e.g. to a house entry system. An example of this would be an RF resonator loop antenna. There might be a chance that certain vehicles could use this kind of passive key systems in the future.

In some embodiments, a server may obtain or check the built and design of, e.g. user's vehicle, or other device attributes like smartkey or keyless entry system upon registration or use. Other information may include financial institution credit card or payment information etc.

A minimal identity recovery system could be either subscribed to by at a subscription fee, or alternatively the system could charge at a use-based fee upon use rather than using a subscription based.

In a subscription case, user might be allowed certain number of uses per year or other period or other bases.

Different levels of subscription could be used. For instance, in a more comprehensive and expensive systems, recovery data may include contacts information, certain settings, etc.

In one embodiment, the present invention presents a method comprising obtaining recovery data, which is normally used on a mobile device, and saving the data in a database such that it is available for minimal identity recovery in case one has no access to the mobile device.

Such a database may be maintained in secure place with a failover mechanism and a certain record or file in that database could become readily available upon request.

Such a request might be a query request to the database which is done at specific instances by a server.

Such a server might, for instance. be contacted by an automatic or semi-automatic machine (or software application) upon request and/or identification, validation, authorization.

Such validation might, for instance, be a secure authentication or other validation. One example would be a multi-factor authentication which may or may not use biometric information. Alternatively the authentication could be semi-automatic in which case a representative on the provider side would be present.

Some embodiments present a method comprising providing recovery data by a server to a recovery agent which data is used normally on a mobile device, for minimal identity recovery in case one has no access to the mobile device.

The recovery agent could, for instance, be a machine that has dispensable recovery medium upon request and validation.

Some embodiments provide a method comprising obtaining recovery data from a server by a recovery agent, which data is used normally on a mobile device, and which data is used for minimal identity recovery in case one has no access to the mobile device.

Some embodiments provide a method comprising electronically loading recovery data onto a recovery medium, which info is used normally on a mobile device, for minimal identity recovery in case one has no access to the mobile device.

Such recovery agent could, for instance, load the recovery data as firmware onto the recovery medium. In this case the recovery medium could include electronic circuitry, like an ASIC circuit or other electronic platform on which the recovery data is loaded.

For certain applications, the recovery medium could, for instance, include an active radio transmitter with a circuit, wherein the recovery medium may also include at least one of a battery and antenna.

For certain applications, the recovery medium could, for instance, include a passive radio transmitter which could, for instance, be an antenna loop or similar device that resonates and or reflects radio signal.

In one embodiment, the present invention presents a system comprising means for dispensing s recovery medium of the methods described.

In one embodiment, the present invention presents a recovery medium comprising means for storing recovery data.

Such medium may be ASIC based and recovery data could loaded as firmware.

Such medium could be set to expire via at least one of battery life and encoded information.

In one embodiment the recovery medium may be another mobile device. As a particular case it could be an inexpensive mobile device with limited capability picked up or purchased from a store or dispensed.

In some embodiments a friend or stranger's mobile device could be used as a recovery medium.

In case the recovery medium is another mobile device, the recovery data may be loaded from a special app or from a feature in the software the cell phone already has. One may choose to load recovery data only temporarily.

In some embodiments, to enable security against and in case of misuse of such a feature, when a user is indeed in possession of own mobile device, a user may get a notification on the mobile device in case a perpetrator tries to revoke recovery data. The user may be prompted to speak or enter a PIN to inhibit misused data recovery.

In some embodiments, the user may choose in advance what capabilities the recovered data should provide.

In some embodiments, certain providers may choose to limit the capabilities of the recovery mode. For example, a bank may limit recovery purchases to a certain limit, such that the user could purchase food or water but not a TV. As another example a recovered smartkey may limit the speed or the range of travel of the car to a certain value in recovery mode.

In some embodiments, there could be more than one level of recovery. For instance, a user may want quick access to limited functionality, but when the user wants a greater set of functionalities or to permanently replace a lost or damaged mobile device with full functionality, a more rigorous security processes may be in place.

In some embodiments, a camera on a mobile device may be used to initiate a video call with to the customer service department. Alternatively the camera could be used to take certain biometric measures such as a headshot. A camera or a different sensor could be used for fingerprint or retinal scan. All or any of these could be used as security measures to enable or inhibit data recovery and could be performed on the recovery medium which could be another mobile device or the original mobile device accordingly.

In some embodiments, certain authentication measures may be pulled by a provider. For instance, a challenge question such as “whom did you call first this morning” may be asked of the user.

In some embodiments, after authentication, a provider may pull up a device locator, for instance on a recovery app, to indicate to the user the location of the lost mobile device. In some embodiments, same app or a different one might be used by the user or provider to trigger a remote wipe of the lost mobile device.

In some embodiments, a rental car company could send code upon a network to a mobile device belonging to a person who wishes to rent a car. The code could for instance run as an application on a smartphone. When the code is run, the mobile device could acts like a smartkey since it has all the capabilities like RF and antenna and power source. It could then be used to operate the rental car or vehicle. All other contractual issues could also be done via the smartphone and the applications and codes within the smartphone. Validation and authentication measures could also be built into the smartphone to ensure that the person having the phone is indeed the person who pays for and is under rental contract agreement.

1. A method comprising obtaining recovery data, which recovery data is normally used on a mobile device, and saving the recovery data in a database such that it is available for minimal identity recovery in case a user has no access to the mobile device, and wherein the recovery data includes at least of one of a smartkey function and a credit card function.

2. The method of claim 1 wherein the database is maintained in a secure place with a failover mechanism and the recovery data in that database could become readily available upon a request.

3. The method of claim 2 wherein the request is a query request to the database which is done by a server.

4. The method of claim 3 wherein the server is contacted by or through an automatic or semi-automatic machine or a software application upon at least one of identification, validation, and authorization.

5. The method of claim 4 wherein the validation is a secure authentication.

6. The method of claim 5 wherein the validation is a multi-factor authentication.

7. The method of claim 4 wherein the validation is semi-automatic, and wherein a representative on a provider side is present.

8. A method comprising providing recovery data by a server to a recovery agent, which recovery data is used normally on a mobile device belonging to a user, in case the user has no access to the mobile device, and wherein the recovery agent enables the user to perform at least one of a smartkey function and a credit card function.

9. The method of claim 8 wherein the recovery agent is a machine that has a dispensable recovery medium.

10. A method comprising obtaining recovery data from a server by a recovery agent, which recovery data is used normally on a mobile device, and which recovery data is used for minimal identity recovery in case a user has no access to the mobile device, and which recovery data enables the user to perform at least one of a smartkey function and a credit card function.

11. A method comprising electronically loading recovery data onto a recovery medium, which recovery data is used normally on a mobile device, the method being used for minimal identity recovery in case a user has no access to the mobile device, and wherein the recovery data includes at least one of a smartkey function and a credit card function.

12. The method of claim 11 wherein the recovery agent is adapted to load the recovery data as firmware or software onto the recovery medium.

13. The method of claim 12 wherein the recovery medium includes electronic circuitry, such as an ASIC circuit.

14. A recovery medium for minimal identity recovery, comprising an active radio transmitter with a circuit, wherein the recovery medium also includes an antenna, wherein the circuit and the antenna are used in combination to send radio signals, and wherein the recovery medium enables a user to perform at least one of a smartkey function and a credit card function.

15. A recovery medium for minimal identity recovery, comprising a passive radio transmitter having an antenna that resonates and reflects radio signal upon being in the vicinity of an active transmitter, and wherein the recovery medium enables a user to perform at least one of a smartkey function and a credit card function.

16. A system comprising means for automatically dispensing a recovery medium containing recovery data which recovery data is used normally on a mobile device.

17. A recovery medium comprising means for storing recovery data, which recovery data is used normally on a mobile device, wherein the recovery medium is used temporarily to enable a user to perform at least one of a smartkey function and a credit card function.

18. The method of claim 17 wherein the recovery medium is ASIC based and the recovery data is loaded as firmware or software.

19. The method of claim 17 wherein the recovery medium is set to expire.

20. The method of claim 19 wherein an expiry time is established via at least one of battery life and encoded information.

21. A method for providing recovery data, which recovery data is used normally on a first mobile device, said method comprising sending the recovery data to a second mobile device, and wherein the second mobile device thereby enables a user to perform at least one of a smartkey function and a credit card function in case the user has no access to the first mobile device.

22. The method of claim 21 wherein the second mobile device is inexpensive compared to the first mobile device.

23. The method of claim 22 wherein the second mobile device has limited capability compared to the first mobile device.

24. The method of claim 22 wherein the second mobile device is dispensed or purchased.

25. The method of claim 21 wherein the the second mobile device belongs to a different person than the first mobile device.

26. The method of claim 21 wherein the recovery data is loaded from a special app.

27. The method of claim 21 wherein the recovery data is set to reside on the second mobile device for a limited period of time.

28. The method of claim 21, further sending a notification to the first mobile device in case a perpetrator tries to revoke the recovery data from the second mobile device.

29. The method of of claim 28 wherein the user of the first mobile device is prompted to speak or enter a PIN to validate a user identity or to inhibit revoking data recovery.

30. A method for storing and providing recovery data for minimal identity recovery of a user, the recovery data normally residing on a mobile device, the method comprising allowing the user to choose in advance what capabilities the recovery data should provide.

31. The method of claim 30 further limiting purchases to a certain limit or limiting the speed or range of travel of a car to a certain limit.

32. The method of claim 30 wherein there is more than one level of recovery.

33. The method of claim 32 further enabling a user of the recovery data for quick access to limited functionality, and when the user wants a greater set of functionalities or to permanently replace a lost or damaged mobile device with full functionality, requiring a more rigorous security processes.

34. The method of claim 21 further using a camera or sensor for user validation.

35. The method of claim 34 further initiating a video call to a user of the second mobile device.

36. The method of claim 35 wherein the camera or sensor is used to take certain biometric measures such as at least one of a headshot, a fingerprint, and a retinal scan.

37. The method of claim 20 further using a challenge question to validate a user.

38. The method of claim 20 further pulling up a device locator.

39. The method of claim 38, wherein the device locator is run as a recovery app on the second mobile device to indicate to a user the location of the first mobile device.

40. A method for providing a rental vehicle to a user, the method comprising providing code to a mobile device from a server in possession of the user, which code is adapted to enable the mobile device to operate as a smartkey.

41. The method of claim 40 wherein the mobile device is enabled to lock, unlock, and start the engine of the rental vehicle.
